(19) United States
(12) Patent Application Publication
(10) Pub. No.: US 2023/0215712 A1
(43) Pub. Date: Jul. 6, 2023

(54) IMPROVED ION CONVERSION PLATE

(71) Applicant: ADAPTAS SOLUTIONS PTY LTD, CLYDE, NEW SOUTH WALES (AU)

(72) Inventors: Russell Jurek, Clyde, New South Wales (AU); Toby Shanley, Clyde, New South Wales (AU)

(21) Appl. No.: 18/001,155

(22) PCT Filed: Jun. 7, 2021
(86) PCT No.: PCT/AU2021/050567

§ 371 Date: Dec. 8, 2022

(30) Foreign Application Priority Data
Jun. 9, 2020 (AU) 2020901880
Jul. 23, 2020 (AU) 2020902555

(51) Int. Cl. H01J 43/14; H01J 43/02; H01J 49/02

(52) U.S. Cl. CPC H01J 43/14; H01J 43/02; H01J 49/025; H01J 49/40

(57) ABSTRACT

Scientific analytical equipment including apparatus and methods for detecting and quantitating particles, and particularly ions generated in the course of mass spectroscopy. In one version, a particle detection apparatus includes electron emissive surfaces which emit secondary electrons in response to impact with a particle, the apparatus maintaining spatial separation between: (i) secondary electrons emitted as a result of the impact of a first particle in a first region of the electron emissive surface; and (ii) secondary electrons emitted as a result of the impact of a second particle in a second region of the electron emissive surface.

### FIELD OF THE INVENTION

.The present invention relates to generally to components of scientific analytical equipment. More particularly, the invention relates to apparatus and methods for detecting and quantitating particles, and particularly ions generated in the course of mass spectroscopy.

### BACKGROUND TO THE INVENTION

.Mass spectrometry is a well-known technique used in chemical analysis. Typically, a sample comprising a number of different molecular species is ionized in some manner such that each molecule becomes charged (normally positively charged by the removal of an electron). The so-formed ions are then accelerated and formed into a beam. The beam is in turn directed toward an analyser of some type, which filters ions according to their mass, before directing the ‘selected’ ions to a detector.

. By way of example, one type of analyser is a magnetic sector analyser. In a magnetic sector analyser, an ion beam is directed through a magnetic field that is oriented perpendicular to it. The magnetic field deflects the ion beam in an arc having a radius inversely proportional to the mass of each ion. Lighter ions are deflected to a greater degree than heavier ions. In this way, ions are separated according to their mass-to-charge ratio (m/z). By varying the strength of the magnetic field, ions of different mass are focused progressively on an ion detector disposed outside the magnetic field. The abundance of each of the separated ions is then measured, and the results displayed on a chart, often termed a “mass spectrum”. Ions are, of course, highly reactive and accordingly their formation, separation and detection within a mass spectrometer is performed under a vacuum, typically of about 10⁻⁵ to 10⁻⁸ torr.

. It is generally desirable for a mass spectrometer to display a high linear dynamic range to allow for accurate counting of both high and low abundance ions. Protein profiling is an exemplary application requiring a high dynamic range mass spectrometer. Protein profiling is a powerful method for analysing protein expression patterns in cells and tissues. Typically, sample material has a high degree of protein complexity and a large dynamic range of proteins are expressed in the complex biological mixtures. In samples of cellular material a high abundance protein may be present at a level of six orders of magnitude greater than a low abundance protein. In samples of bodily fluids, the difference in abundances may be even greater at around ten orders of magnitude.

. The performance of a mass spectrometer may be at least partially limited by the maximum linear output signal from a detector relative to the maximum possible input of simultaneously arriving particles. For example, for a multiplier gain required to detect a single ion (10 mV into 50 ohm pre-amp input impedance), it is currently not possible to measure more than around 500 ions arriving simultaneously at the input. Put another way, a multiplier becomes saturated at around 500 ions under circumstance where a gain capable of detecting a single ion is used. Thus, in many circumstances the dynamic range of an ion detector may be compromised for sensitivity.

. A further limitation specific to time-of-flight mass spectrometry is the less than desirable mass resolution which arises due to a difference in arrival time of ions having the same m/z at the ion-electron conversion surface of a detector. This difference in arrival time may be due to different optical path-lengths, different velocities of ions of the same m/z ratio, a non-flat ion-electron conversion surface; or to an ion-electron conversion surface that is not perfectly normal to the axis of ion arrival. The practical effect of poor mass resolution is that two ions which are identical are detected as separate species, or two different ions are detected as the same species.

. Prior artisans have made efforts over many years to address these limitations, with varying levels of success. One approach attempts to increase the linear dynamic range by deriving two signals from the avalanche of secondary electrons produced by the electron multiplier of the detector. The first signal is a signal of low amplification (being produced in the early stages of electron multiplication) and therefore suitable for detecting and quantitating high abundance ions. The second signal (being taken in the later stages of electron multiplication) is more highly amplified and therefore suitable for detecting and quantitating low abundance ions. Saturation effects may be observed in later stages of amplification, and so a signal from an earlier stage of amplification will remain linear even at high ion intensities and without saturation effects. For a discrete dynode detector this principle may be practically achieved by disposing a detection grid between two dynodes early in the amplification chain.

. While signal splitting approaches can be effective, difficulties arise where very high dynamic ranges are needed and the signal is necessarily split at multiple stages of electron amplification. A first cause of difficulty may be due to the input to the various amplification stages being common such that saturation of the input for a higher gain amplifier affecting the input of lower gain amplifiers later in the amplification chain. Under some circumstances signal distortion and mass measurement inaccuracies can result.

. A second cause of difficulty may arise due to the overall signal intensity being reduced for each splitting step. Multiple signal splitting may necessitate increasing the overall gain of the multiplier to ensure proper detection of single ions. However, the maximum output pulse of the electron multiplier overall may be exceeded where a large number of ions impinge within a short period of time leading to nonlinearity in the response.

. Taking a simple example, where the detector comprises two microchannel plates, each of the two plates capable of amplifying by a factor of, say, 10³ so as to provide a total amplification of about 10⁶. If greater than 10⁴ ions arrive at the detector within a counting period, the second plate is not capable of emitting the more than 10¹⁰ secondary electrons required to produce a signal which is proportional to the ion current.

. Prior artisans have addressed that problem by installing a grid between the two microchannel plates, the grid transmitting only about 50% of electrons emitted by the first plate to the second plate. Thus, around half of the electrons emitted by the first plate fall on the grid to produce a first signal of relatively low amplification, while the remaining electrons pass through the grid and impact the second plate for further amplification. The electrons from the second plate are collected by the anode and produce a second more highly amplified signal. The separate amplification and digitization of the first and second signals allows for the generation of a combined signal with high linear dynamic range.

. Other approaches include the application of separate digitisers on the first and second signals, along with processing circuitry configured to (i) determine first intensity and arrival time, mass or mass to charge ratio data from the first digitised signal; and processing circuitry configured to (ii) determine second intensity and arrival time, mass or mass to charge ratio data from the second digitised signal; and (iii) combine the first intensity and arrival time, mass or mass to charge ratio data and the second intensity and arrival time, mass or mass to charge ratio data to form a combined data set. The combined dataset may be obtained by firstly determining respective intensity and arrival time, mass or mass to charge ratio data (e.g. peak detecting the digitised signals), and then combining the resulting intensity and arrival time, mass or mass to charge ratio data (e.g. time and intensity pairs).

. It is an aspect of the present invention to provide improved apparatus and methods for the detection of particles that is improved in terms of dynamic range, mass resolution or any other parameter. A further aspect of the present invention provides a commercially useful alternative to prior art apparatus and methods.

. The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

. In a first aspect, but not necessarily the broadest aspect, the present invention provides a particle detection apparatus comprising electron emissive surface(s) configured to emit secondary electrons in response to impact with a particle, wherein the apparatus is configured so as to maintain spatial separation between (i) secondary electrons emitted as a result of the impact of a first particle in a first region of the electron emissive surface and (ii) secondary electrons emitted as a result of the impact of a second particle in a second region of the electron emissive surface,

. In one embodiment of the first aspect, the first and second regions of the electron emissive surface(s) do not overlap.

. In one embodiment of the first aspect, the first and second regions of the electron emissive surface(s) abut.

. In one embodiment of the first aspect, each of the first and second regions of the electron emissive surfaces(s) has a linear edge, and the linear edges of the first and second regions abut.

. In one embodiment of the first aspect, each of the first and second regions of the electron emissive surfaces(s) has an axis and the axes are substantially mutually parallel.

. In one embodiment of the first aspect, the electron emissive surface(s) are fabricated from an electrically resistive material.

. In one embodiment of the first aspect, the particle detection apparatus comprises electrodes disposed under, over, in, on, or about the electron emissive surface(s), the electrodes positioned such that in use a first electric field is established above the electron emissive surface of the first region, and a second electric field is established above the electron emissive surface of the second region, wherein the first and second electric fields are configured to maintain separation between (i) secondary electrons emitted as a result of the impact of a first particle in a first region of the electron emissive surface and (ii) secondary electrons emitted as a result of the impact of a second particle in a second region of the electron emissive surface.

. As will be appreciated from a consideration of the preferred embodiment of the drawings, the first and second electric fields are not necessarily discrete electric fields. For example, first and second electric fields may be established using a single electrode pair, however analysis of the field lines allows for first and second electric fields to be discerned.

. In one embodiment of the first aspect, the electrodes are opposed, and typically linear and mutually parallel.

. In one embodiment of the first aspect, the first of the opposed electrodes runs along an edge of the electron emissive surface that is proximal to a target electrode configured to receive a secondary electrode, and the second of the opposed electrodes runs along an edge of the electron emissive surface that is distal to the target electrode

. In one embodiment of the first aspect, the second of the opposed electrodes comprises elongate regions extending toward the first of the opposed electrodes.

. In one embodiment of the first aspect, the first and second electric fields are configured so as to transport secondary electrons emitted by the first and second regions of the electron emissive surface(s) toward an edge of the first or second regions of the electron emissive surface(s) respectively.

. In one embodiment of the first aspect, the first and second electric fields are configured so as to transport secondary electrons emitted by the first and second regions in the same general direction.

. In one embodiment of the first aspect, wherein the first and second regions of the electron emissive surface(s) have an axis, and the first and second electric fields are configured so as to transport secondary electrons emitted by the first and second regions in a direction generally parallel to the respective axis.

. In one embodiment of the first aspect, wherein the first and second electric fields are characterized by having lines of electrostatic equipotential that rise above the first and second regions of the electron emissive surface respectively.

. In one embodiment of the first aspect, wherein the lines of electrostatic equipotential that rise above the first region of the electron emissive surface(s) do not intersect with the lines of electrostatic equipotential that rise above the second region of the electron emissive surface(s).

. In one embodiment of the first aspect, wherein the first and second electric fields are each crossed with a magnetic field.

. In one embodiment of the first aspect, wherein the first and second electric fields are configured to transport secondary electrons along a non-linear path.

. In one embodiment of the first aspect, wherein the non-linear path is a cycloidal path.

. In one embodiment of the first aspect, wherein the non-linear path of a secondary electron emitted by the electron emissive surface of the first region does not enter the space above the electron emissive surface of the second region.

. In one embodiment of the first aspect, the particle detection apparatus comprises first and second electron multipliers, the first electron multiplier configured to receive and amplify secondary electrons emitted from the first region of the electron emissive surface(s) and the second electron multiplier configured to receive and amplify secondary electrons emitted from the second region of the electron emissive surface(s).

. In one embodiment of the first aspect, the particle detection apparatus is configured such that a secondary electron emitted from the first region of the electron emissive surface(s) is inhibited or prevented from entering the second electron multiplier, and a secondary electron emitted from the second region of the electron emissive surface(s) is inhibited or prevented from entering the first electron multiplier.

. In one embodiment of the first aspect, the first and/or second electron multipliers is/are a multi-dynode electron multiplier, a continuous electron multiplier (CEM), a multi-channel CEM, a micro channel plate (MCP) electron multiplier and/or a cross-field multiplier (including a time-of-flight configuration such as MagneTOF™).

. In one embodiment of the first aspect, the particle detection is configured such that a secondary electron that has entered into or been emitted by the first electron multiplier is prevented from entering the second electron multiplier, and a secondary electron that has entered into or been emitted by the second electron multiplier is prevented from entering the first electron multiplier.

. In one embodiment of the first aspect, the particle detection apparatus is configured as a multichannel ion conversion plate capable of emitting second electrons due to impact of an ion therewith, the plate further capable of spatially constraining secondary electrons emitted due to impact of an ion at a first position on the plate and spatially constraining secondary electrons emitted due to impact of an ion at a second position on the plate.

. In one embodiment of the first aspect, the particle detection comprises a first target electrode and a second target electrode, wherein the first electron target electrode is configured to receive electrons transported from the first region of the electron emissive surface(s), and the second target electrode is configured to receive electrons from the second region of the electron emissive surface(s).

. In one embodiment of the first aspect, the first target electrode and second target electrode are each a dynode of an electron multiplier (including a discrete dynode electron multiplier, a continuous electron multiplier (CEM), a multi-channel CEM; a cross-field electron multiplier (including a time-of-flight configuration such as MagneTOF™), and a micro channel plate (MCP), or an electron collector.

. In one embodiment of the first aspect, the particle detection apparatus comprises processing means configured to receive a signal as input from the electron multiplier or the electron collector, wherein the processing means is configured to mathematically transform the signals such that the apparatus functions so as to have a dynamic range or mass resolution that is greater than the dynamic range of a similar apparatus having a single region of the electron emissive surface(s).

. In a second aspect, the present invention provides a mass spectrometer comprising the particle detection apparatus of any embodiment of the first aspect.

. In a third aspect, the present invention provides a method for the detection of particles, the method comprising: providing electron emissive surfaces(s), establishing an electric field(s) above the electron emissive surface(s), the electric field(s) configured to spatially constrain secondary electrons emitted due to impact of a particle at a first position on the electron emissive surface and spatially constraining secondary electrons emitted due to impact of a particle at a second position on the electron emissive surface, causing or allowing a particle to impact at a first position on the electron emissive surface, causing or allowing a particle to impact at a second position on the electron emissive surface, and separately collecting secondary electrons emitted resulting from the particle impacting at the first position on the electron emissive surface and secondary electrons resulting from the particle impacting at the second position on the electron emissive surface.

. In one embodiment of the third aspect, first and second electric fields are established, the first electric field configured so as to spatially constrain secondary electrons emitted due to impact of a particle at a first position on the electron emissive surface, and the second electrical field configured so as to spatially constraining secondary electrons emitted due to impact of a particle at a second position on the electron emissive surface.

. In one embodiment of the third aspect, the first and second electric fields are configured so as to transport secondary electrons emitted by the first and second regions of the electron emissive surface(s) toward an edge of the first or second regions of the electron emissive surface(s) respectively.

. In one embodiment of the third aspect, the first and second electric fields are configured so as to transport secondary electrons emitted by the first and second regions in the same general direction.

. In one embodiment of the third aspect, the first and second regions of the electron emissive surface(s) have an axis, and the first and second electric fields are configured so as to transport secondary electrons emitted by the first and second regions in a direction generally parallel to the respective axis.

. In one embodiment of the third aspect, the first and second electric fields are characterized by having lines of electrostatic equipotential that rise above the first and second regions of the electron emissive surface respectively.

. In one embodiment of the third aspect, the lines of electrostatic equipotential that rise above the first region of the electron emissive surface(s) do not intersect with the lines of electrostatic equipotential that rise above the second region of the electron emissive surface(s).

. In one embodiment of the third aspect, the first and second electric fields are each crossed with a magnetic field.

. In one embodiment of the third aspect, the first and second electric fields are configured to transport secondary electrons along a non-linear path.

. In one embodiment of the third aspect, the non-linear path is a cycloidal path.

. In one embodiment of the third aspect, the non-linear path of a secondary electron emitted by the electron emissive surface of the first region does not enter the space above the electron emissive surface of the second region.

. In one embodiment of the third aspect, the electron emissive surface(s) are provided by the particle detection apparatus of any embodiment of the first aspect

### BRIEF DESCRIPTION OF THE FIGURES

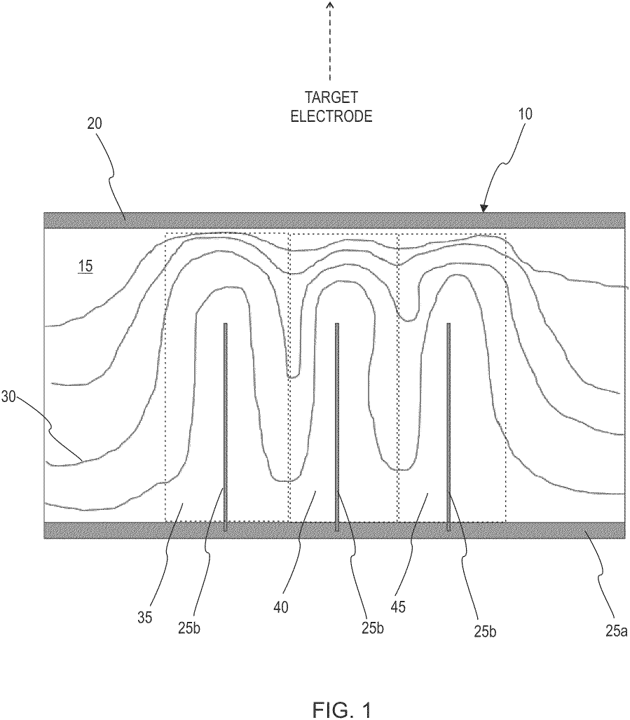

. FIG. 1 shows in a highly diagrammatic manner a plan view of a preferred ion converter plate of the present invention

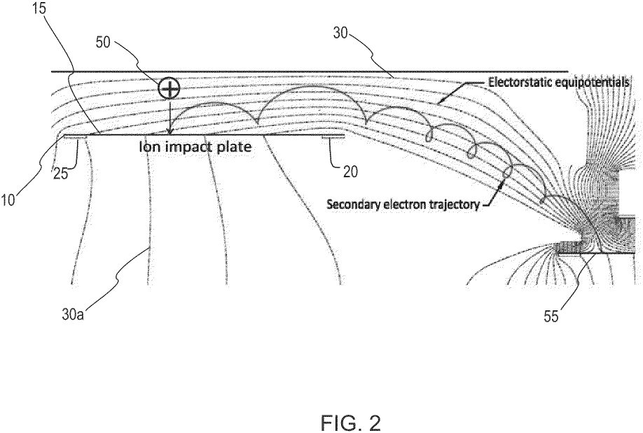

. FIG. 2 shows in a highly diagrammatic manner a lateral view of a preferred ion converter plate in the context of a mass spectrometer.

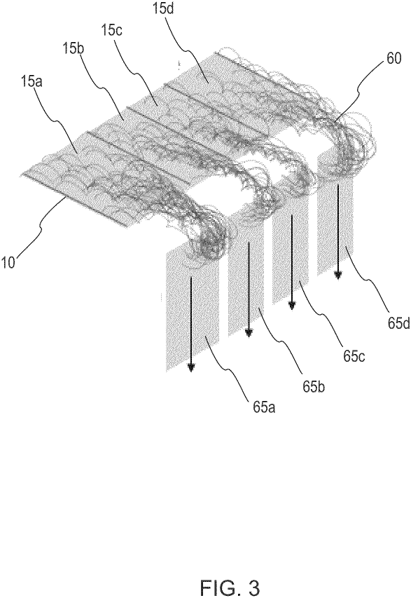

. FIG. 3 shows in highly diagrammatic form a perspective view of a preferred ion converter having 4 discrete channels, the converter coupled with amplifying means.

### DETAILED DESCRIPTION OF THE INVENTION

. After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

. Throughout the description and the claims of this specification the word “comprise” and variations of the word, such as “comprising” and “comprises” is not intended to exclude other additives, components, integers or steps.

. Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

. The present particle detection apparatus is useful as a multi-channel ion detector that may be configured to be operable in a one-to-one mapping arrangement (whereby spatial separation is maintained between the channels), or in a many-to-one mapping arrangement (two or more spatially separated channels are combined into a single channel)

. With regard to the one-to-one mapping arrangement secondary electrons emitted by an ion detector may be spatially constrained within a region of ion detector surface so as to allow for secondary electrons resulting from impacts of multiple ions to be quantitated separately. An ion detector of the present invention may be used, therefore, as a multichannel device allowing for the division of ions and their associated secondary electrons into discrete channels. The electron signal output by each discrete channel may be separately amplified (by discrete electron multipliers, for example) and separately quantitated using separate electron collectors (by discrete anode collector plates, for example). The output of each channel may be used so as to identify a region of the ion converter surface upon which an ion has impacted, and/or improve dynamic range of the ion converter, and/or improve mass resolution of the ion converter.

. With regard to the many-to-one mapping arrangement, electrons from multiple spatially separated regions may be directed to a single target location. For example, the apparatus may comprise ten regions and secondary electrons from each of the ten regions are directed to a single target electrode. This allows for “super-sampling” of an ion beam and in turn lessens variation in sensitivity that arises from changes in the beam profile and/or the effect of beam position. In a variation of this approach electrons emitted from each of the ten regions may be directed alternately to one of two target electrodes. By this arrangement, response linearity may be doubled (with respect to the linear range).

. Whilst the present invention is described mainly by reference to the detection of ions, it will be understood that the invention is applicable also to the detection of other particles including neutral particles (i.e. non-charged particles including atomic, subatomic and molecular species), and charged particles that are not necessarily ions such as electrons and protons.

. As used herein, the terms “ion detector”, “particle detector”, “particle detection apparatus” and the like are intended to mean a physical apparatus that is capable of emitting secondary electrons when impacted by a single particle. Upon impact by a particle, the detector may emit from its surface two or more secondary electrons, as is well understood in the art. Typically, a large number of secondary electrons are emitted for each particle that impacts on the detector surface, thereby resulting in an amplified electron signal which may be directly quantitated, or quantitated after further amplification.

. Attention is firstly turned to physical and functional aspects of the particle detection apparatus of the present invention. In terms of materials, the electron emissive surface(s) may be composed of any material known in the prior art for the emission of secondary electrons upon impact with any charged or uncharged particle. The material may also have a minimum electrical resistance. Processed (reduced and then re-oxidised) resistive glass is an exemplary material that provides both resistive and secondary emission properties. Given the benefit of the present specification, other useful materials will be apparent to the skilled person.

. The particle apparatus may consist of a single electron emissive surface which is divided into first and second regions, or two electron emissive surfaces each of which defines a single region, or three electron emissive surfaces across which two regions are defined, or four electron emissive surfaces across which two regions are defined, etc. Typically, a single electron emissive surface is provided across which the first and second regions are defined. In many embodiments of the invention, the particle detection apparatus has 3, 4, 5, 6, 7, 8, 9, 10 or more regions.

. Each of the regions of the particle detection apparatus may be considered a channel in the context of a multichannel device. Thus an apparatus having 2, 3, 4, 5, 6, 7, 8, 9, or at least 10 regions may provide 2, 3, 4, 5, 6, 7, 8, 9, or at least 10 channels respectively.

. The inventive concept may in theory be generalized to an apparatus having any number of regions (channels) and any arrangement of electron emissive surface(s), with the proviso that the practical application thereof is reliant on configuring the optics (i.e. the manipulation of particle flow) accordingly.

. As used herein, the term “channel” is intended to include a discrete electron signal path. .Ideally, the present particle detection apparatus is configured so as to have zero, or substantially zero cross-talk between channels. Embodiments having some cross-talk may still be operable to some extent, and are therefore included within the ambit of the present invention. As compared with the maximum or typical signal handled by a channel, cross-talk between adjacent channels may be less than about 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.01%, or 0.001%, 0.0001%. As will be appreciated, it will be desirable for cross-talk to be minimised so as to provide greater confidence that any electron signal produced by a region of the electron emissive surface is due exclusively to a particle that has impacted within that region.

. The particle detection apparatus is configured so as to maintain spatial separation between (i) secondary electrons emitted as a result of the impact of a first particle in a first region of the electron emissive surface and (ii) secondary electrons emitted as a result of the impact of a second particle in a second region of the electron emissive surface. By this arrangement, a particle that impacts a first region (channel) results in the generation of secondary electrons within the first region (channel), and a particle that impacts a second region (channel) results in the generation of secondary electrons within the second region (channel), with secondary electrons being inhibited from crossing from the first region (channel) to the second region (channel), or from the second region (channel) to the first region (channel).

. The first or second region of the electron emissive surface may be defined by reference to a physical landmark such as the edge of the electron emissive surface or a border with an associated feature such as a conductive electrode. In some embodiments the border of the first or second region may have no physical basis, and may be defined by reference to some function or property of the electron emissive surface, or any material underlying the electron emissive surface, or any electric or magnetic field above the electron emissive surface. In some embodiments the first or second region may be only notionally defined.

. In many embodiments, the first and second regions are regularly shaped, and typically are identically shaped. First and second regions typically have a regular geometry and often a rectangular geometry, being disposed side-by-side and abut along a long edge.

. Where the first and second regions have a regular geometry, each region will have an axis. Generally the axes will be mutually parallel. Regularly-shaped first and second regions which are mutually parallel facilitates the maintenance of spatial separation between secondary electrons emitted within the first region and secondary electrons emitted within the second region. In many embodiments the secondary electrons of the first region are transported by an electric field which is generally orientated along an axis of the first region, and the secondary electrons of the second region are transported by an electric field which is generally orientated along an axis of the second region. Thus, where the secondary electrons are transported along mutually parallel electrical fields, the opportunity for cross-over of electrons from the first region to the second region (or vice-versa) is lessened because the path taken by the electrons in each region are also mutually parallel.

. As will be appreciated, secondary electrons emitted in the first and second regions must be eventually transported away from their respective originating electron emitting surfaces and toward a target electrode of some description for the purposes of amplification and/or quantitation.

. An electric field may be used for electron transportation. In many embodiments of the invention, the electron emissive surface is electrically resistive and in such circumstances an electric field may be established above the electron emissive surface. Electric field lines remain above the electron emissive surface until a secondary electron rises from the surface and in which case a field line is caused to originate from the surface, and rise above the surface. The secondary electron may be transported along a so-formed equipotential field line originating from the point of its creation on the electron emissive surface and toward a collector, as will be more fully described infra.

. The electric fields above the first and second regions of an electron emissive surface may be established by electrodes which are positioned at least proximally to the electron emissive surface concerned.

. In some embodiments, the electrodes are disposed on an electrically resistive surface of an electron emitting surface. Thus, any electric current applied to the electrodes does not pass through the material of the electron emissive surface with the electric field being therefore established above the surface.

. In other embodiments, one of the electrodes is an anode (which functions also as an electronic collector). The other of the electrodes is opposed to the anode, being directly across from and on the opposing side of the electron emissive surface such that electric field lines extend generally parallel to an axis of the first or second region of the electron emissive surface.

. Some embodiments of the invention use multiple electrodes in contact with a single resistive electrode to create multiple regions on the single resistive electrode. In that context, an exemplary form of the invention may include or be in functional association with a reverse bias impact plate configured to direct electrons from each region to separate targets (e.g. separate dynode plates; specific locations on a single dynode plate; different detectors, or specific locations in a single detector). The reverse bias impact plate is fabricated from an electron emissive material and (by way of an electrical potential gradient generating means) is configured to generate an electrical potential gradient within the emissive material, the electrical potential gradient being oriented so as to vary from positive to negative in the general direction toward the electron target such that an electron emitted from the emissive material is deflected away therefrom and generally toward the electron target. Further teachings in relation to the construction and operation of reverse bias impact plates is found in published international patent WO/2017/015700; the contents of which is herein incorporated by reference.

. It will be appreciated that any optics component required to guide a particle spatially may or may not be physically associated with any electron emissive surface(s) of the present particle detection apparatus.

. Preferably, the particle detection apparatus is configured such that the secondary electrons are transported to a target electrode along a complex path, such as a non-linear path or a path that is not a simple curve. An exemplary complex path is a cycloidal path, and in preferred embodiments causes the electron to exhibit a “bouncing” action between a pair of potentials, on its path from the electron emissive surface to the target electrode.

. A cycloidal electron path may be established by way of a crossed-field configuration, whereby an electric field is crossed (orthogonally) with a magnetic field. Means for establishing a crossed-field are known, and having the benefit of the present specification the skilled person is enabled to apply such knowledge to the present invention.

. Without wishing to be limited by theory in any way, it is proposed that secondary electrons emitted by the emissive surface follow a trajectory outwardly from the surface and then back toward the surface as a result of the magnetic field which is oriented substantially orthogonal to the plane of electron flow. In returning toward the emissive surface, an electron is deflected away from the surface by the electrostatic field in the region immediately above the surface.

. It is further proposed that the electron is deflected at the level of an equipotential field line extending from the point on the emissive surface from which the electron was emitted. Once the electron traverses through the equipotential which passes through its origin toward the emissive surface it will lose all of its energy (velocity) and experience an electrostatic field which pushes it back through the equipotential and continues to accelerate it away from the surface. This is similar to rolling a ball up hill, where it eventually stops and then starts rolling back down the hill. This explanation neglects the electron’s initial energy, as it is emitted from the surface, which will be near negligible for practical applications. The equipotential spacing or the field gradient above the surface must be large enough to allow for this initial energy to be lost before the electron reaches the surface. In practice this is a minimal requirement.

. After a first deflection an electron may be deflected a second, third, fourth, fifth, six, seventh, eighth, ninth, tenth time, or even a greater number of times as the magnetic field continues to curve the electron’s trajectory toward the surface and the electrostatic equipotential deflects it away when it gets too close. The various field parameters may be adjusted so that the electron undergoes only one or two deflections on its way to the target. In this way, the electron is bounced along an equipotential line above the emissive surface, and toward the target electrode. This bouncing continues until the electron crosses an edge of the emissive area at which point the field lines are squeezed between the emissive area and the target. The electron’s momentum then carries it onto the target electrode.

. Cycloidal electron transfer by crossed fields is particularly effective at moving electrons through complex pathways, as the electron is confined to a narrow range of electrostatic equipotentials that rise from the position of the electron emissive surface at which the electron originated. The electron kinetic energies remain relatively low as they are continually accelerated and decelerated by the combined effect of the orthogonal electric and magnetic fields, while at the same time maintaining a drift velocity orthogonal to both electric and magnetic fields so as to be transported along the lines of electrostatic equipotentials and toward the target electrode. Once the electron passes the edge of the electron emissive material and out of the first or second region, control of the electron is maintained by the crossed field extending toward the target electrode.

. In order for secondary electrons to be transported toward the target electrode, an electrostatic gradient on the electron emissive surface may run toward the collector.

. The physical means for establishing the electric field may be any means deemed suitable by a skilled person given the benefit of the present specification. Given the functional requirements of the electric field as disclosed herein, the skilled person is able to conceive of many and varied means for establishing the field. In one embodiment, the emissive surface is electrically resistive. As used herein, the term “electrically resistive” includes any level of resistance so long as an electric potential can be established and maintained across the emissive surface. As will be understood by the skilled person the resistance must be large enough so as not to require more power than is practical for the apparatus. It is contemplated that at least 1, 2, 3, 4 or 5 megohms will be practical.

. Using cycloidal electron transport with complex resistive emission plates facilitates correlation between the position of electron origin, and the final impact position on the target electrode.

### DETAILED DESCRIPTION OF PREFERRED EMBODIMENTS OF THE INVENTION

. Turning firstly to FIG. 1 there is shown in plan view of an ion convertor plate (10) fabricated from an electron emissive material which is also electrically resistive. The ion converter plate has an electron emissive surface (15) which is configured to receive a stream of ions from an ion source of a mass spectrometer, and upon impact each ion (not drawn) emits a plurality of secondary electrons (not drawn). Thus, the ion converter plate (10) functions so as to convert an incoming ion into an amplified electron signal.

. The ion converter plate (10) comprises a first electrode (20) and a second electrode (25), both electrodes (20) and (25) being fabricated from a conductive material disposed on the electron emissive surface (15). The electrodes (20) (25) may be composed of any electrically conductive material, however preferred materials include evaporated aluminium or conductive epoxy.

. In alternative embodiments, the electrodes (20) and (25) may not contact the electron emissive surface (15), or indeed any part of the electrically resistive material from which the ion converter plate (10) is principally fabricated.

. The broad function of the electrodes (20) (25) is to establish an electric field above the electron emissive surface (15). The first electrode (20) has a potential that is more positive than that of the second electrode (25). As an example, the first electrode (20) may have a potential of +200 V and the second electrode (25) may have a potential of 0 V. The broad effect of such voltage biasing is to transport any secondary electrons toward the more positive electrode (i.e. the first electrode (20)), and then across the edge of the plate and toward a target electrode, in the direction as indicated by the dashed arrow.

. An aim of the present invention is to spatially constrain secondary electrons within a volume of space immediately above the electron emissive surface. The ion converter plate (10) is configured to facilitate such spatial constraint by way of the elongate extensions (25b) which originate from and are in electrical connection with the main portion (25b) of the electrode. The elongate extensions (25) each deform the lines of equipotential (one of which marked 30), as shown in FIG. 1. It will be noted that the lines of equipotential (30) form finger-like arrangements, with a concentration of the lines in the region between the terminus of each elongate extension (25b) and the first electrode (20). This arrangement of lines of equipotential (30) facilitates the transport of secondary electrons toward the first electrode (20), and transport of the electrons off the upper edge (as drawn) of the ion converter plate (10) and toward a target electrode. It will be seen therefore that by this arrangement that a secondary electron will avoid travelling laterally and in that regard is spatially constrained.

. The finger-like arrangement of the filed lines of equipotential (30) divide the electron emissive surface (15) into three regions (35) (40) (45) as delineated by the dashed rectangles. A secondary electron that is emitted from within region (35) will tend to travel toward the first electrode 20, and avoid moving laterally into the adjacent region 40. In this way, any secondary electron that exits the ion converter plate from about the upper short edge of the region (35) could be assumed to have originated in region (35). Similarly, any secondary electron that exits the ion converter plate from about the upper short edge of the region (40) could be assumed to have originated in region (40), and any secondary electron that exits the ion converter plate from about the upper short edge of the region (45) could be assumed to have originated in region (45).

. Each of the regions (35) (40) (45) may be considered as a channel of a multichannel device, and the equipotential field lines (35) acting to inhibit cross-talk between adjacent channels.

. There is no requirement for the first and second regions to be of identical area, however in some embodiments this will be the case. Regions of unequal area may be used where, for example, the first region is expected to receive a relatively large number of impacting particles (in which case a relatively large area may be provided). Regions of unequal area may be used to ensure equal incident ion flux in circumstances where one region would receive a greater flux if equal area regions were to be used. Equalising flux allows for some uniformity in ‘wear’ and ‘ageing’ of the target surface(s) and/or detector(s), and also facilitates combining multiple output signals.

. The use of unequal areas can also provide higher uniformity in the ion beam, by directing different amounts of ion input to target surface(s) and/or detector(s) that are operating at identical gain. The differences in ion input is equivalent to attenuation. This in turn allows an improvement in dynamic range. The “attenuated” ion input from the smaller region will remain within the detector’s linear operating range, while the other larger region’s ion input will not.

. Reference is made now to FIG. 2 which shows a lateral view of the ion converter plate (10) showing the cycloidal trajectory of a secondary electron emitted as a result of impact by an ion (50). It will be noted that some field lines (one shown as 30a) extend through the ion converter plate (10). In this embodiment, the electric field is crossed orthogonally or substantially orthogonally with a magnetic field (not shown). As is understood in the art, a uniform magnetic field B may be established with an electric field E at right angles to the magnetic field. Electrons that start out perpendicular to B will move in a curve and as its speed increases is bent less by the magnetic field B. When it is going against the electric field E, it loses speed and is continually bent more by the magnetic field B. The net effect is that it the electron has an average drift in the direction of E×B.

. The electron’s motion is in fact a circular motion superimposed on a sidewise motion at a speed to provide a cycloid trajectory as shown in FIG. 2.

. Staying with FIG. 2 it will be noted that the secondary electron is transported beyond the first electrode (20) and into space, although the electron is still controlled and maintained in a cycloidal trajectory by the field (30). The electron eventually impacts onto a target electrode which in this preferred embodiment is the first dynode (55) of an electron multiplier. As will be understood, for a discrete dynode multiplier the electron impacts on the first dynode thereby releasing a plurality of secondary electrons (not shown), each of which are transported to a second dynode, with secondary electrons emitted by the second dynode being transported to a third dynode and so on until an avalanche of secondary electrons arrives at a terminal collector for signal quantitation. Where the electron multiplier is a continuous electron multiplier or a cross-field multiplier, multiple impacts and amplification events occur along a single emissive surface.

. Each region (channel) of the ion impact plate (10) has its own dedicated electron multiplier. This is more clearly shown in FIG. 3 which shows a 4 channel plate (10) in having 4 regions of the electron emissive surface (15a) (15b) (15c) (15d) which provide 4 streams of secondary electrons (one marked 60). Each stream of electrons has a dedicated amplifier (65a) (65b) (65c) (65d), each being a continuous dynode as representative of a MagneTOF™ detector, the gain for each may be independently controlled as required. The arrowed lines show the downward direction of secondary electrons through each electron multiplier (65a) (65b) (65c) (65d). As will be readily understood, electron multipliers other than the continuous dynode type may be substituted.

. After amplification, the resultant electrons are typically quantitated by impacting a collector anode. The output of the collector anode may be used by a processor.

. The present invention allows for the use of multiple amplification channels originating from a single ion-electron conversion plate. The signals from these channels may be electronically combined in post processing software. The channels can operate at different gains, or be used to amplify nominal relative portions of the input so as to increase dynamic range of the system.

. The use of multiple channels allows for correlation between an amplified signal with an ion impact position, thus allowing ion arrival time correction based on position in post processing. One or more advantages are provided in the context of time-of-flight (“TOF”) mass spectrometry, that allow ion arrival time correction based on position in post processing to improve mass accuracy and resolution. A first advantage is that the multiple channels provide statistically independent measurements of the time between ion impact and pulse output. This allows multiple pulses to be combined together in a manner so as to reduce some of the statistical uncertainty in the output pulse arrival time. A second advantage is that each channel can be calibrated independently. This allows for each channel to have a unique correction for any systematic uncertainty in the output pulse arrival time. Additionally, differences in ion arrival across the impact plate (which is a form of ‘ion jitter’), may be calibrated out to some extent at least. A further advantage is that the number of regions can be increased until each region is sufficiently small such that the corresponding ion jitter is decreased.

. The use of multiple channels further allows for an increase in dynamic range of the detector. The gain of a one channel may be set differently (higher or lower) to other channel(s) so as to improve response linearity across a range or across a broader range than would otherwise be available where only a single channel with a single gain setting is used. In addition or alternatively, each of the multiple channels may be subject to different levels of signal attenuation, which again allows for improvements in linearity. Detectors described as “dual-mode” are known in the art and are suitable for setting differential attenuation or gain levels in respect of the multiple channels of the present invention.

. The general construction, materials, physical dimensions and spatial arrangement of the various electron emissive surface(s) may be selected by the skilled person according to a particular desired end, and having the benefit of the present specification.

. In the embodiment of the drawings, and indeed in other embodiments, the ion impact plate (being an exemplary electron emissive surface(s) configured to emit secondary electrons in response to impact with a particle) of the detector may have an axis, and the axis may be rotated with respect to the axis of a channel or the axes of two channels. The angle of rotation may be greater than zero degrees, and up to about 90 degrees. In some embodiments, the rotation angle is about 90 degrees. Where required, the regions (channels) may be physically stacked, and optionally stacked in a staggered manner with some overlap between adjacent regions so as to expose a target area. The voltage applied to the target area of each element in the stack will typically correspond to the equipotentials of the corresponding region (channel) on the impact plate.

. As discussed supra, an ion beam may be ‘super-sampled’ by the use of many electrodes to create many regions. This is achieved by grouping the regions, and assigning each group of regions a common target (i.e. a many-to-one mapping). It’s why mechanical attenuators of electron/ion flux use lots of very small slots instead of a single big hole. Unfortunately, the manufacturing and optics is a lot harder.

. The size of the regions may be limited by the impact plate materials, electron emission energies and cross-talk requirements. The voltage across any small region may be sufficiently large enough to trap emitted electrons, and is some embodiments to maintain the electrons in a cycloidal trajectory. The electrical properties of the impact plate materials will determine the minimum physical size based on this minimum voltage. A ‘buffer’ will then typically be added to achieve the necessary reduction of cross-talk. The buffer can take the form of additional size, physical separation or a physical cross-talk shield.

. It will be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

. In the description provided herein, numerous specific details are set forth. However, it is understood that embodiments of the invention may be practiced without these specific details. In other instances, well-known methods, structures and techniques have not been shown in detail in order not to obscure an understanding of this description.

. Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the diagrams and operations may be interchanged among functional blocks. Steps may be added or deleted to methods described within the scope of the present invention.

. Although the invention has been described with reference to specific examples, it will be appreciated by those skilled in the art that the invention may be embodied in many other forms.

1. A particle detection apparatus comprising:
a first electron emissive surface and a second electron emissive surface, each of the first and second electron emissive surfaces configured to emit secondary electrons in response to impact with a particle, wherein the apparatus is configured so as to maintain spatial separation between (i) secondary electrons emitted by the first electron emissive surface and (ii) secondary electrons emitted by the second electron emissive surface by electric field lines established above the first and second electron emissive surfaces.

2. The particle detection apparatus of claim 1, wherein the first and second electron emissive surfaces (i) do not overlap and/or (ii) abut.

3. (canceled)

4. The particle detection apparatus of claim 1, wherein each of the first and second electron emissive surfaces has a linear edge, and the linear edges abut.

5. The particle detection apparatus of claim 1 4, wherein each of the first and second electron emissive surfaces has an axis and the axes are substantially mutually parallel.

6. The particle detection apparatus of claim 1, wherein the first and second electron emissive surfaces are fabricated from an electrically resistive material.

7. The particle detection apparatus of claim 1, further comprising electrodes disposed under, over, in, on, or about the first and second electron emissive, which are arranged to establish the electric field lines.

8. The particle detection apparatus of claim 7, wherein the electrodes are opposed such that the electric field lines extend across and above the first and second electron emissive surfaces.

9. (canceled)

10. (canceled)

11. The particle detection apparatus of claim 7, wherein the electrodes are arranged so that the first and second electric field lines are oriented so as to transport secondary electrons emitted by the first and second electron emissive surfaces toward an edge of the first or second electron emissive surface respectively.

12. (canceled)

13. The particle detection apparatus of claim 7, wherein each of the first and second electron emissive surfaces has an axis, and the electrodes are arranged so that the electric field lines are orientated so as to transport secondary electrons emitted by the first and second electron emissive surfaces in a direction generally parallel to the respective axis.

14. The particle detection apparatus of claim 7, wherein the electrodes are arranged and configured so that the electric field lines are characterized by having lines of electrostatic equipotential that rise above the first and second electron emissive surfaces respectively.

15. The particle detection apparatus of claim 14, wherein the lines of electrostatic equipotential that rise above the first electron emissive surface do not intersect with the lines of electrostatic equipotential that rise above the second electron emissive surface.

16. The particle detection apparatus of claim 7, further comprising a source of a magnetic field arranged so that wherein the electric field lines are each crossed with the magnetic field.

17. The particle detection apparatus of claim 7, wherein the electrodes and the first and second electron emissive surfaces are arranged so that the electric field lines transport secondary electrons along a cycloidal path.

18. (canceled)

19. The particle detection apparatus of claim 17, wherein the cycloidal path of a secondary electron emitted by the first electron emissive surface does not enter the space above the second electron emissive.

20. The particle detection apparatus of claim 1 comprising first and second electron multipliers, the first electron multiplier configured to receive and amplify secondary electrons emitted from the first electron emissive surface and the second electron multiplier configured to receive and amplify secondary electrons emitted from the second electron emissive surface.

21. The particle detection apparatus of claim 20, configured such that a secondary electron emitted from the first electron emissive surface is inhibited or prevented from entering the second electron multiplier, and a secondary electron emitted from the second electron emissive surface is inhibited or prevented from entering the first electron multiplier.

22. (canceled)

23. The particle detection apparatus of claim 21, configured such that a secondary electron that has entered into or been emitted by the first electron multiplier is prevented from entering the second electron multiplier, and a secondary electron that has entered into or been emitted by the second electron multiplier is prevented from entering the first electron multiplier.

24. The particle detection apparatus of claim 1 in the form of a multichannel ion conversion plate capable of emitting second electrons due to impact of an ion therewith, the plate further capable of spatially constraining secondary electrons emitted due to impact of an ion at a first position on the plate and spatially constraining secondary electrons emitted due to impact of an ion at a second position on the plate.

25. The particle detection apparatus of claim 20 comprising a first target electrode and a second target electrode, wherein the first target electron target is configured to receive electrons transported from the first electron emissive surface, and the second target electrode is configured to receive electrons from the second electron emissive surface.

26. (canceled)

27. (canceled)

28. (canceled)

29. A method for the detection of particles, the method comprising:
providing one or more electron emissive surfaces,
establishing electric field lines above the one or more electron emissive surfaces to, spatially constrain secondary electrons emitted due to impact of a particle at a first position on the one or more electron emissive surfaces and spatially constraining secondary electrons emitted due to impact of a particle at a second position on the one or more electron emissive surfaces,
causing or allowing -a particle to impact at a first position on the one or more electron emissive surfaces,
causing or allowing -a particle to impact at a second position on the one or more electron emissive surfaces, and
separately collecting secondary electrons emitted resulting from the particle impacting at the first position and secondary electrons resulting from the particle impacting at the second position.

30. FAKE CLAIM DELETE.

31. (canceled)

32. (canceled)

33. (canceled)

34. (canceled)

35. (canceled)

36. (canceled)

37. (canceled)

38. (canceled)

39. (canceled)

40. (canceled)

41. (canceled)
